(19) United States
(12) Patent Application Publication
(10) Pub. No.: US 2012/0154423 A1
(43) Pub. Date: Jun. 21, 2012

(54) LUMINANCE-BASED DITHERING TECHNIQUE

(75) Inventors: Ulrich T. Barnhoefer, Cupertino, CA (US); Taif Ahmed Syed, Toronto (CA)

(73) Assignee: APPLE INC., Cupertino, CA (US)

(21) Appl. No.: 12/970,510

(22) Filed: Dec. 16, 2010

(51) Int. Cl. G09G 5/02; G06K 9/00

(52) U.S. Cl. 345/590; 382/167

(57) ABSTRACT

Systems and methods are disclosed to enable the creation and the display of dithered images. Embodiments include techniques that use the relationship between the luminance and the color of a source image as a dithering heuristic. In one embodiment, the luminance and the color of a source image is determined. Each color of the source image is approximated to the nearest hardware color level. The hardware color level is then varied to more closely approximate the luminance of the source image. Any color errors introduced by approximating the luminance of the source image are then diffused to adjacent pixels.

### BACKGROUND

The present disclosure relates generally to techniques for dithering images using a luminance approach.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic displays are typically configured to output a set number of colors within a color range. In certain cases, a graphical image to be displayed may have a number of colors greater than the number of colors that are capable of being shown by the electronic display. For example, a graphical image may be encoded with a 24-bit color depth (e.g., 8 bits for each of red, green, and blue components of the image), while an electronic display may be configured to provide output images at an 18-bit color depth (e.g., 6 bits for each of red, green, and blue components of the image). Rather than simply discarding least-significant bits, dithering techniques may be used to output a graphical image that appears to be a closer approximation of the original color image. However, the dithering techniques may not approximate the original image as closely as desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to dithering techniques that may be used to display color images on an electronic display. The electronic display may include one or more electronic components, including a power source, pixelation hardware (e.g., light emitting diodes, liquid crystal display), and circuitry for receiving signals representative of image data to be displayed. In certain embodiments, the processor may be internal to the display while in other embodiments the processor may be external to the display and included as part of an electronic device, such as a computer workstation or a cell phone.

The processor may use dithering techniques, including luminance-based dithering techniques disclosed herein, to output color images on the electronic display. In luminance-based dithering, the relationship between a luminance and the color of pixels in a source image is determined. The color components of the source image (e.g., red, green, and blue components) are approximated to their nearest hardware color level. The hardware color level is then varied to more closely approximate the luminance of the source image. Color errors that may be introduced by approximating the luminance of the source image are then diffused to adjacent pixels.

### BRIEF DESCRIPTION OF THE DRAWINGS

Various aspects of this disclosure may be better understood upon reading the following detailed description and upon reference to the drawings in which:

FIG. 1 is a simplified block diagram depicting components of an example of an electronic device that includes image processing circuitry configured to implement one or more of the image processing techniques set forth in the present disclosure;

FIG. 2 is a front view of the electronic device of FIG. 1 in the form of a desktop computing device, in accordance with aspects of the present disclosure;

FIG. 3 is a front view of the electronic device of FIG. 1 in the form of a handheld portable electronic device, in accordance with aspects of the present disclosure;

FIG. 4 shows a graphical representation of an M×N pixel array that may be included in the display of FIG. 1, in accordance with aspects of the present disclosure;

FIG. 5 is a block diagram illustrating an image signal processing (ISP) logic that may be implemented in the image processing circuitry of FIG. 1, in accordance with aspects of the present disclosure;

FIG. 6 is a logic diagram illustrating the operation of the display of FIG. 1, in accordance with aspects of the present disclosure;

FIG. 7 is a block diagram further illustrating luminance-based dithering, in accordance with aspects of the present disclosure;

FIG. 8 is a first view illustrating error diffusion in accordance with aspects of the present disclosure;

FIG. 9 is a second view illustrating error diffusion in accordance with aspects of the present disclosure; and

FIG. 10 is a third view illustrating error diffusion in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

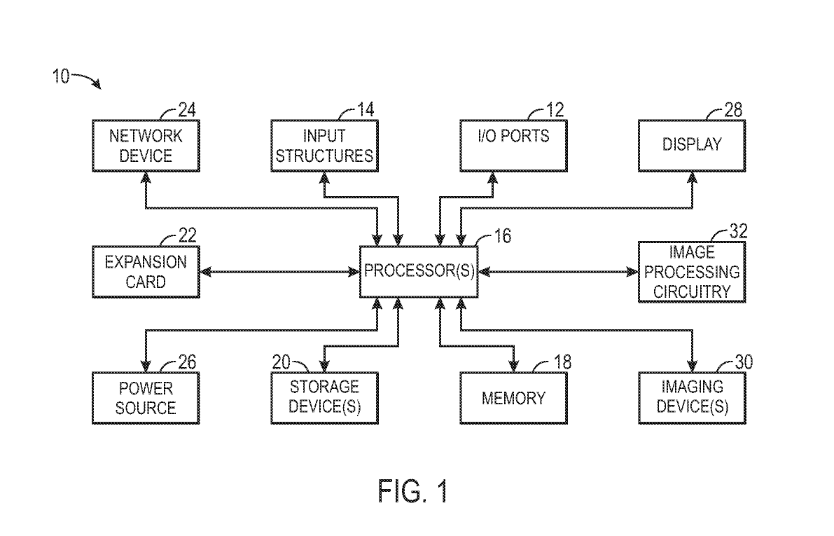

With the foregoing in mind, it may be beneficial to first discuss embodiments of certain display systems that may incorporate the dithering techniques as described herein. With this in mind, and turning now to the figures, FIG. 1 is a block diagram illustrating an example of an electronic device 10 that may provide for the processing of image data using one or more of the image processing techniques briefly mentioned above. The electronic device 10 may be any type of electronic device, such as a laptop or desktop computer, a mobile phone, a digital media player, television, or the like, that is configured to process and display image data, such as data acquired using one or more image sensing components. By way of example only, the electronic device 10 may be a portable electronic device, such as a model of an iPod® or iPhone®, available from Apple Inc. of Cupertino, Calif. Additionally, the electronic device 10 may be a desktop or laptop computer, such as a model of a MacBook®, MacBook® Pro, MacBook Air®, iMac®, Mac® Mini, or Mac Pro®, available from Apple Inc.

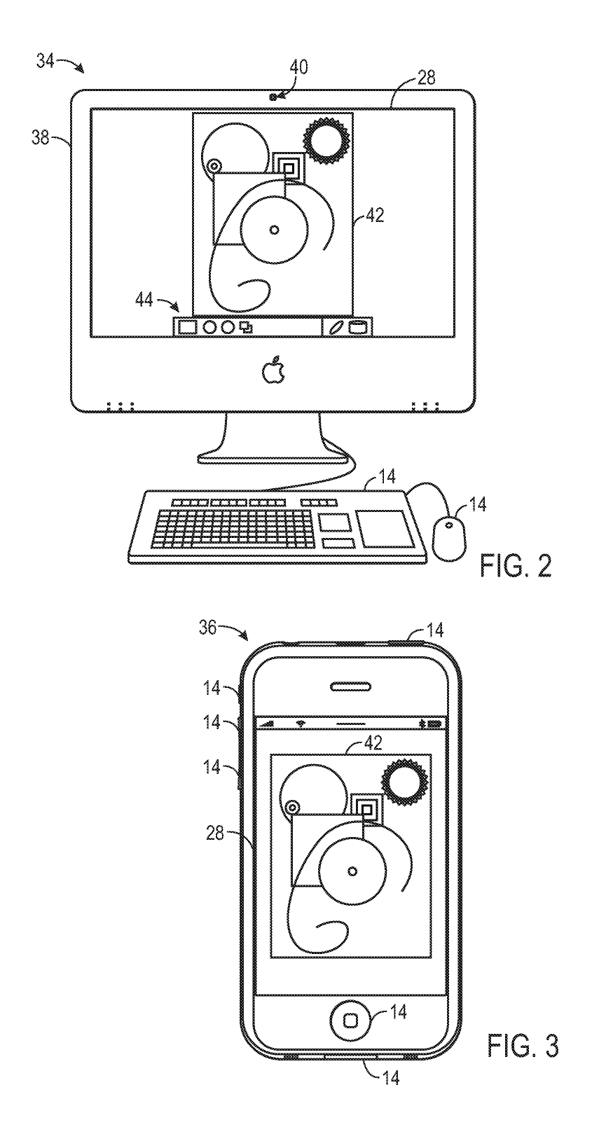

Regardless of its form (e.g., portable or non-portable), it should be understood that the electronic device 10 may provide for the processing of image data using one or more of the image processing techniques briefly discussed above, which may include luminance analysis and error diffusion dithering techniques, among others. In some embodiments, the electronic device 10 may apply such image processing techniques to image data stored in a memory of the electronic device 10. Embodiments showing both portable and non-portable embodiments of electronic device 10 will be further discussed below with respect to FIGS. 2 and 3.

As shown in FIG. 1, the electronic device 10 may include input/output (I/O) ports 12, input structures 14, one or more processors 16, memory device 18, non-volatile storage 20, expansion card(s) 22, networking device 24, power source 26, and display 28. Additionally, the electronic device 10 may include one or more imaging devices 30, such as a digital camera, and image processing circuitry 32. As will be discussed further below, the image processing circuitry 32 may be configured to implement one or more of the above-discussed image processing techniques. As can be appreciated, image data processed by image processing circuitry 32 may be retrieved from the memory 18 and/or the non-volatile storage device(s) 20, or may be acquired using the imaging device 30.

Before continuing, it should be understood that the system block diagram of the device 10 shown in FIG. 1 is intended to be a high-level diagram depicting various components that may be included in such a device 10. Indeed, as discussed below, the depicted processor(s) 16 may, in some embodiments, include multiple processors, such as a main processor (e.g., CPU), and dedicated image and/or video processors. The input structures 14 may provide user input or feedback to the processor(s) 16. For instance, input structures 14 may be configured to control one or more functions of electronic device 10, such as applications running on electronic device 10. In one embodiment, input structures 14 may allow a user to navigate a graphical user interface (GUI) displayed on device 10. Additionally, input structures 14 may include a touch sensitive mechanism provided in conjunction with display 28. In such embodiments, a user may select or interact with displayed interface elements via the touch sensitive mechanism.

In addition to processing various input signals received via the input structure(s) 14, the processor(s) 16 may control the general operation of the device 10. For instance, the processor(s) 16 may provide the processing capability to execute an operating system, programs, user and application interfaces, and any other functions of the electronic device 10. The processor(s) 16 may include one or more microprocessors, such as one or more “general-purpose” microprocessors, one or more special-purpose microprocessors and/or application-specific microprocessors (ASICs), or a combination of such processing components. For example, the processor(s) 16 may include one or more reduced instruction set (e.g., RISC) processors, as well as graphics processors (GPU), video processors, audio processors and/or related chip sets. In certain embodiments, the processor(s) 16 may provide the processing capability to execute source code embodiments capable of employing the image processing techniques described herein.

The instructions or data to be processed by the processor(s) 16 may be stored in a computer-readable medium, such as a memory device 18. The memory device 18 may be provided as a volatile memory, such as random access memory (RAM) or as a non-volatile memory, such as read-only memory (ROM), or as a combination of one or more RAM and ROM devices. The memory 18 may store a variety of information and may be used for various purposes. For example, the memory 18 may store firmware for the electronic device 10, such as a basic input/output system (BIOS), an operating system, various programs, applications, or any other routines that may be executed on the electronic device 10, including user interface functions, processor functions, and so forth. In addition, the memory 18 may be used for buffering or caching during operation of the electronic device 10. For instance, in one embodiment, the memory 18 includes one or more frame buffers for buffering video data as it is being output to the display 28.

In addition to the memory device 18, the electronic device 10 may further include a non-volatile storage 20 for persistent storage of data and/or instructions. The non-volatile storage 20 may include flash memory, a hard drive, or any other optical, magnetic, and/or solid-state storage media, or some combination thereof. In accordance with aspects of the present disclosure, image data stored in the non-volatile storage 20 and/or the memory device 18 may be processed by the image processing circuitry 32 prior to being output on a display.

The embodiment illustrated in FIG. 1 may also include one or more card or expansion slots. The card slots may be configured to receive an expansion card 22 that may be used to add functionality, such as additional memory, I/O functionality, networking capability, or graphics processing capability to the electronic device 10. The electronic device 10 also includes the network device 24, which may be a network controller or a network interface card (NIC) that may provide for network connectivity over a wireless 802.11 standard or any other suitable networking standard, such as a local area network (LAN), a wide area network (WAN).

The power source 26 of the device 10 may include the capability to power the device 10 in both non-portable and portable settings. The display 28 may be used to display various images generated by device 10, such as a GUI for an operating system, or image data (including still images and video data) processed by the image processing circuitry 32, as will be discussed further below. As mentioned above, the image data may include image data acquired using the imaging device 30 or image data retrieved from the memory 18 and/or non-volatile storage 20. The display 28 may be any suitable type of display, such as a liquid crystal display (LCD), plasma display, or an organic light emitting diode (OLED) display, for example. Additionally, as discussed above, the display 28 may be provided in conjunction with the above-discussed touch-sensitive mechanism (e.g., a touch screen) that may function as part of a control interface for the electronic device 10. The illustrated imaging device(s) 30 may be provided as a digital camera configured to acquire both still images and moving images (e.g., video).

The image processing circuitry 32 may provide for various image processing steps, such as spatial dithering, error diffusion, pixel color-space conversion, luminance determination, luminance optimization, image scaling, and so forth. In some embodiments, the image processing circuitry 32 may include various subcomponents and/or discrete units of logic that collectively form an image processing “pipeline” for performing each of the various image processing steps. These subcomponents may be implemented using hardware (e.g., digital signal processors or ASICs) or software, or via a combination of hardware and software components. The various image processing operations that may be provided by the image processing circuitry 32 and, particularly those processing operations relating to spatial dithering, error diffusion, pixel color-space conversion, luminance determination, and luminance optimization, will be discussed in greater detail below.

Referring again to the electronic device 10, FIGS. 2 and 3 illustrate various forms that the electronic device 10 may take. As mentioned above, the electronic device 10 may take the form of a computer, including computers that are generally portable (such as laptop, notebook, and tablet computers) as well as computers that are generally non-portable (such as desktop computers, workstations and/or servers), or other type of electronic device, such as handheld portable electronic devices (e.g., a digital media media player or mobile phone). In particular, FIGS. 2 and 3 depict the electronic device 10 in the form of a desktop computer 34 and a handheld portable electronic device 36, respectively.

FIG. 2 further illustrates an embodiment in which the electronic device 10 is provided as the desktop computer 34. As shown, the desktop computer 34 may be housed in an enclosure 38 that includes a display 28, as well as various other components discussed above with regard to the block diagram shown in FIG. 1. Further, the desktop computer 34 may include an external keyboard and mouse (input structures 14) that may be coupled to the computer 34 via one or more I/O ports 12 (e.g., USB) or may communicate with the computer 34 wirelessly (e.g., RF, Bluetooth, etc.). The desktop computer 34 also includes an imaging device 40, which may be an integrated or external camera, as discussed above. In certain embodiments, the desktop computer 34 may be a model of an iMac®, Mac® mini, or Mac Pro®, available from Apple Inc. As further shown, the display 28 may be configured to generate various images that may be viewed by a user, such as a dithered image 42. The dithered image 42 may have been generated by using, for example, luminance-based dithering techniques described in more detail herein. During operation of the computer 34, the display 28 may display a graphical user interface (“GUI”) 44 that allows the user to interact with an operating system and/or application running on the computer 34.

Turning to FIG. 3, the electronic device 10 is further illustrated in the form of portable handheld electronic device 36, which may be a model of an iPod® or iPhone® available from Apple Inc. The handheld device 36 includes various user input structures structures 14 through which a user may interface with the handheld device 36. For instance, each input structure 14 may be configured to control one or more respective device functions when pressed or actuated. By way of example, one or more of the input structures 14 may be configured to invoke a “home” screen or menu to be displayed, to toggle between a sleep, wake, or powered on/off mode, to silence a ringer for a cellular phone application, to increase or decrease a volume output, and so forth. It should be understood that the illustrated input structures 14 are merely exemplary, and that the handheld device 36 may include any number of suitable user input structures existing in various forms including buttons, switches, keys, knobs, scroll wheels, and so forth. In the depicted embodiment, the handheld device 36 includes the display device 28. The display device 28, which may be an LCD, OLED, or any suitable type of display, may display various images generated by the techniques disclosed herein. For example, the display 28 may display the dithered image 42.

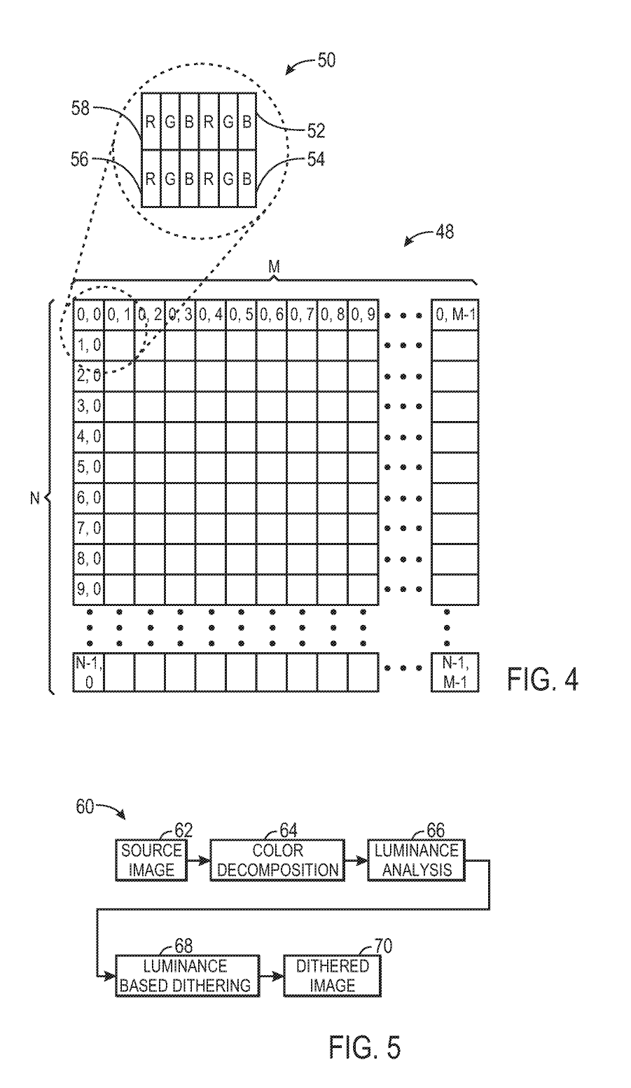

Having provided some context with regard to various forms that the electronic device 10 may take and now turning to FIG. 4, the present discussion will focus on details of the display device 28 and on the image processing circuitry 32. As mentioned above, the display device 28 may be any suitable type of display, such as a liquid crystal display (LCD), plasma display, a digital light processing (DLP) projector, an organic light emitting diode (OLED) display, and so forth. The display 28 may include a matrix of pixel elements such as an example M×N matrix 48 depicted in FIG. 4. Accordingly, the display 28 is capable of presenting an image at a natural display resolution of M×N. For example, in embodiments where the display 28 is included in a 30 inch Apple Cinema HD Display®, the natural display resolution may be approximately approximately 2560×1600 pixels.

A pixel group 50 is depicted in greater detail and includes four adjacent pixels 52, 54, 56, and 58. In the depicted embodiment, each pixel of the display device 28 may include three sub-pixels capable of displaying a red (R), a green (G), and a blue (B) color. The human eye is capable of perceiving a particular RGB color combination and translating the combination into a certain color. By varying the individual RGB intensity levels, a number of colors may be displayed by each individual pixel. For example, a pixel having a level of 50% R, 50% G, and 50% B may be perceived colored gray, while a pixel having a level of 100% R, 100% G, and 0% B may be perceived as colored yellow.

The number of colors that a pixel is capable of displaying is dependent on the hardware capabilities of the display 28. For example, a display 28 with a 6-bit color depth for each sub-pixel is capable of producing 64 (2⁶) intensity levels for each of the R, G, and B color components. The number of bits per sub-pixel, e.g. 6 bits, is referred to as the pixel depth. At a pixel depth of 6 bits, 262,144 (2⁶×2⁶×2⁶) color combinations are possible, while at pixel depth of 8 bits, 16,777,216 (2⁸×2⁸×2⁸) color combinations are possible. Although the visual quality of images produced by an 8-bit pixel depth display 28 may be superior to the visual quality of images produced by a display 28 using 6-bit pixel depth, the cost of the 8-bit display 28 is also higher. Accordingly, it would be beneficial to apply imaging processing techniques, such as the techniques described herein, that are capable displaying a source image with improved visual reproduction even when utilizing lower pixel depth displays 28. Further, a source image may contain more more colors than those supported by the display 28, even displays 28 having higher pixel depths. Accordingly, it would also be beneficial to apply imaging processing techniques that are capable of improved visual representation of any number of colors. Indeed, the image processing techniques described herein, such as those described in more detail with respect to FIG. 5 below, are capable of displaying improved visual reproductions at any number of pixel depths from any number of source images having a greater number of colors than that which can be output by display hardware.

Turning to FIG. 5, the figure is illustrative of an embodiment of an image signal processing (ISP) pipeline logic 60 that may be utilized for processing and displaying a source image 62. The ISP logic 60 may be implemented using hardware and/or software components, such as the image processing circuitry 32 of FIG. 1. A source image 62 may be provided, for example, by placing an electronic representation of the source image 62 onto embodiments of the memory 18. In such an example, the source image 62 may be placed onto frame buffer embodiments of the memory 18. The source image 62 may include colors that are not directly supported by the hardware of the electronic device 10. For example, the source image 62 may be stored at a pixel depth of 8 bits while the hardware includes a 6-bit pixel depth display 28. Accordingly, the source image 62 may be manipulated by the techniques disclosed herein so that it may be displayed in a lower pixel depth display 28.

The source image 62 may first undergo color decomposition (block 64). The color decomposition of block 64 is capable of decomposing the color of each pixel of the source image 62 into the three RGB color levels. That is, the RGB intensity levels for for each pixel may be determined by the color decomposition. Such a decomposition may be referred to as a three-channel decomposition, because the colors may be decomposed into a red channel, a green channel, and a blue channel, for example.

In the depicted embodiment, the source image 62 may also undergo luminance analysis (block 66). A luminance is related to the perceived brightness of an image or an image component (such as a pixel) to the human eye. Further, humans typically perceive colors as having different luminance even if each color has equal radiance. For example, at equal radiances, humans typically perceive the color green as having higher luminance than the color red. Additionally, the color red is perceived as having a higher luminance than the color blue. In one example, a luminance formula Y may be arrived at by incorporating observations based on the perception of luminance by humans as defined below.

Y=0.30R+0.60G+0.10B

Indeed, the luminance equation Y above is an additive formula based on 30% red, 60% green, and 10% blue chromaticities (e.g., color values). The luminance formula Y can thus use the RGB color levels of a pixel to determine an approximate human perception of the luminance of the pixel. It is to be understood that because of the variability of human perception, among other factors, the values used in the luminance equation are approximate. Indeed, in other embodiments, the percentage values for R, G, and B may be different. For example, in another embodiment, the values may be approximately 29.9% red, 58.7% green, and 11.4% blue.

In another example, a formula Y′ may be arrived at by applying a gamma transformation to each color value R, G, B. More specifically, the color values R, G, and B may be gamma transformed into a linear space by raising each respective color value to a power coefficient such as 2.2, resulting in R′=R^{2.2}, G′=G^{2.2}, and Y′=Y^{2.2}. Accordingly, the gamma transformation into linear space may result in the formula defined below.

Y′=0.30R′+0.60G′+0.10B′

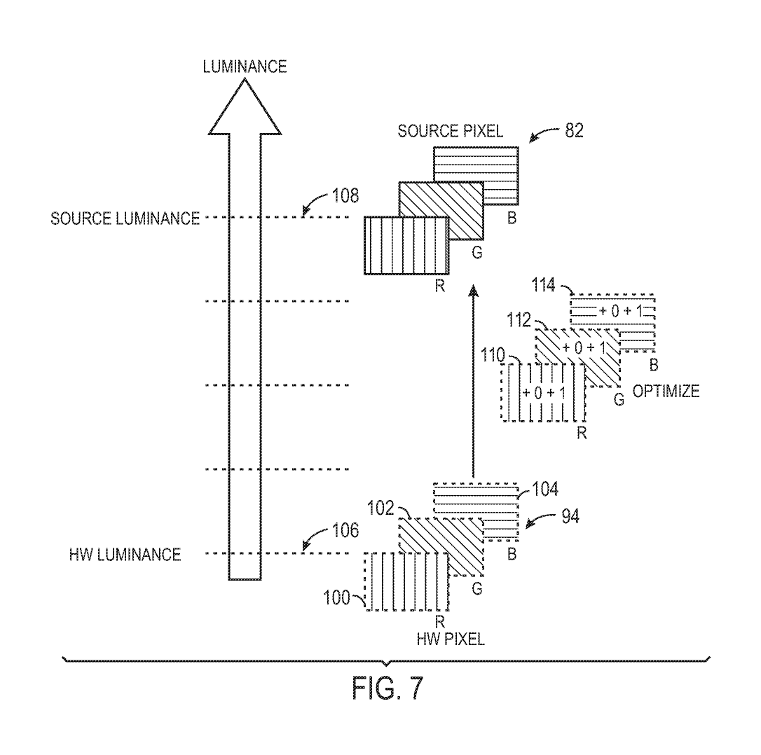

It is to be understood that, in other embodiments, the power coefficient 2.2 may have other values, such as 1.5, 1.8, 1.9, 2.0, 2.1, 2.3, 2.4, 2.5, or 2.8. Additionally, the percentage values for R′, G′, and B′ may also be different. For example, in another embodiment, the values may be approximately 29.9% R′, 58.7% G′, and 11.4% B′. In certain embodiments, the gamma-transformed luminance Y′ may be derived by using the source image 62 RGB values and used, for example, during a luminance-based dithering (block 68) to arrive at a gamma-approximated luminance, as described in more detail below with respect to FIG. 7. In other embodiments, the luminance Y may be derived and used to arrive at a non-linear space approximated luminance.

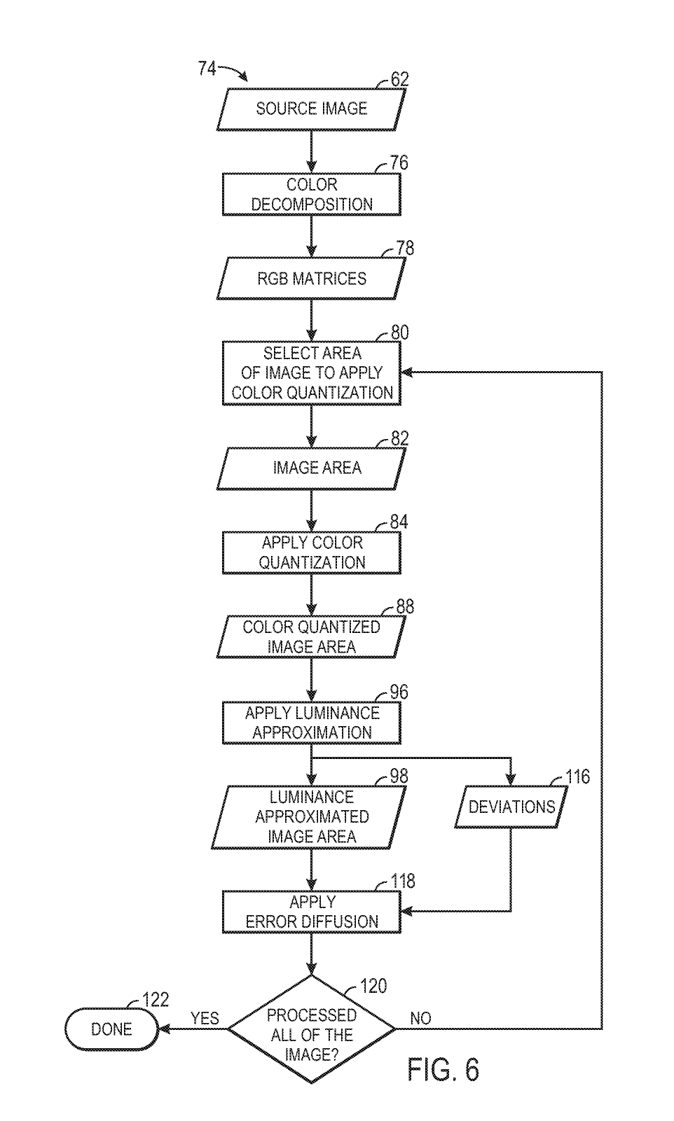

The Y or Y′ luminance value of each pixel may then be utilized for luminance-based dithering (block 68) of the source image 62. In one embodiment of luminance-based dithering, the image may be manipulated by first approximating the color of an area of the source image to be represented by a display pixel to the nearest hardware-supported color. The hardware-supported color area may then be manipulated to more closely approximate the luminance (e.g., Y or Y′) of the original source image area. Such a manipulation may result in deviances from the original image (i.e., “quantization errors”). Accordingly, techniques such as error diffusion may be employed that diffuse the “errors” into adjacent pixels in the image. The image manipulations described with respect to logic 60 are capable of utilizing a single frame of the image and thus may be employed in a wide variety of devices, including devices having limited computational resources. Accordingly, the dithering techniques described herein, such as the luminance-based dithering technique described in more detail with respect to FIG. 6, allow for the presentation of a dithered image 70 (e.g., via display 28) that approximates a source image 62 while having a lower pixel depth.

FIG. 6 is illustrative of an embodiment of a logic 74 capable of utilizing luminance-based dithering techniques to dither the source image 62. That is, the logic 74 is capable of transforming the source image 62 having a higher pixel depth into the dithered image 70 having a lower pixel depth. Accordingly, the logic 74 may include non-transitory machine readable code or computer instructions (e.g., stored in a non-transitory memory, such as memory 18 or storage device 20), that may be used by a processor, for example, to transform image data. The source image 62 may first be decomposed (block 76) into three color components and stored as RGB matrices 78. That is, the resulting RGB color components may be stored in three M×N matrices 78, each matrix corresponding to one of the three color channels. In other embodiments, the color decomposition may be stored in a list, tree, heap or other data structures suitable for storing the three RGB color components of each pixel in the source image 62. Additionally, in other embodiments the color decomposition may decompose an image into a different number of color components or different colors.

The source image 62 may then be divided into image areas, and one of the image areas may then be selected (block 80). In one embodiment, the selected image area 82 may be composed of a single pixel. In other embodiments, the selected image area 82 may be composed of multiple adjacent pixels. A hardware color approximation process, e.g., color quantization (block 84), may then be applied to the selected image area 82. In color quantization (block 84), the image area 82 may have its original RGB color components approximated to the nearest RGB color components that are supported by the hardware. As mentioned above, the original RGB color components may be stored at a higher level pixel depth, such as an 8-bit pixel depth, while the hardware may support a lower level pixel depth, such as a 6-bit pixel depth. Accordingly, a suitable algorithm may be used to find the nearest RGB color levels supported by the hardware.

In some instances, for an image area 82 having a color component value between two adjacent hardware levels, the color component value may be approximated based on its most significant bits. For example, an 8-bit source image color level may be converted to a 6-bit hardware supported color level by using the first six bits of the eight bits of the source image color level. Suppose that the 8-bit red color level is the decimal value “213”, which is equivalent to the binary value “11010101.” The 8-bit red color level could be converted to a 6-bit red color level by using the first six bits, i.e., the binary value “110101” which is equivalent to the decimal value “53.” Accordingly, the decimal value “53” may then be assigned as the red level of a color quantized image area 88. The green and blue color levels may be similarly converted from a higher pixel depth (e.g., 8-bits) to a lower pixel depth (e.g., 6-bits), resulting in the color quantized image area 88.

The logic 74 may then apply luminance approximation (block 96) to the color quantized image area 88. In the luminance approximation (block 96), the color quantized image area 88 may have its RGB color components modified to more closely approximate the luminance (e.g., Y or Y′) of the original colors of the image area 82. As mentioned above, an equation such as the luminance equations Y or Y′, may be used to first calculate the hardware luminance Y_{hw} of the image area 82. In embodiments where the image area 82 may be composed of a single pixel, the luminance equation Y or Y′ would result in a single Y_{hw} value. In embodiments where the image area 82 includes multiple pixels, the luminance for the multi-pixel image area 82 may then be further derived by averaging the luminance values of each pixel, finding a median luminance of the luminance values, or selecting one of the multiple luminance values. The hardware luminance Y_{hw} may then be adjusted so as to more closely approximate the luminance of the original image (e.g., original image luminance Y or Y′).

In certain embodiments, the hardware luminance Y_{hw} may be adjusted by adding and/or subtracting from one or more RGB color levels, as described in more detail below with respect to FIG. 7. If the new luminance value Y_{hw} is greater than the original source luminance Y_{source}, then one or more of the values of the color components RGB of the color quantized image area 88 may be reduced so as to more closely approximate the value Y_{source}. Likewise, if the luminance Y_{hw} is smaller than the source luminance Y_{source}, then one or more of the values of the color components RGB of the color quantized image area 88 may be increased so as to more closely approximate the value Y_{source}. A luminance adjustment range may also be used that defines the range of RGB values to increase or decrease. That is, if the RGB color components are to be adjusted, then the adjustment range may allow for a limit on the increase or in the decrease of the RGB color component levels so as to prevent too great of a color difference. For example, the optimization range may allow for changes in the numeric value of a RGB color component to be of up to 1, 2, 5 or 50 color levels. Such changes in luminance result in the transformation of the color quantized image area 88 into a luminance approximated image area 98.

FIG. 7 depicts an example of the various luminance levels that may be achieved by using the luminance-based techniques described herein. In the illustrated example, the luminance approximated image area 94 (e.g., pixel) may have been color quantized as described above to obtain red, green, and blue color components 100, 102, and 104, respectively, suitable for display by the lower pixel depth hardware. The color components 100, 102, and 104 may result in a hardware luminance level 106 lower than the luminance level 108 of the luminance approximated pixel 98. In one embodiment, the luminance level 108 of the source image pixel may be derived by using the equation for Y′ as described above with respect to FIG. 5. In this embodiment, the RGB luminance may be compared to the luminance level 108 (e.g., Y′) in a linear luminance domain. In another embodiment, the luminance level 108 may be derived using the equation Y. In this embodiment, the RGB luminance may be compared to the luminance level 108 (e.g., Y) in a non-linear domain. The luminance level 106 of the color quantized image area 88 may be raised by adding luminance approximation factors 110, 112, and 114 to the respective color components 100, 102, and 104 so as to more closely approximate the source luminance 108 (e.g. Y or Y′). Indeed, the luminance approximation factors, 110, 112, and 114 are capable of raising (or lowering) the luminance level so as to more luminance level so as to more closely approximate the source luminance level 108. In the illustrated example, the luminance approximation factors, 110, 112, and 114 are capable of adding either a “+1” or a “+0” to the corresponding color components. It is also noted that in some embodiments the luminance approximation factors 110, 112, and 114 may include negative numeric values such as “−1” when the source luminance 108 is smaller than the hardware luminance 106. Indeed, other positive or negative numeric values, such as “−50”, “−15”, “−4”, “−3”, “−2”, “+2”, “+3”, “+4”, “+15”, “+50”, may be used. Indeed, any positive or negative number may be used. By more closely approximating the source luminance level, the resulting lower level pixel depth image may be perceived as more closely approximating the source image 62.

As mentioned above, humans perceived luminance based on an additive contribution of colors. Some colors, such as green, contribute to luminance more than other colors, such as red or blue. Accordingly, the luminance of the source image may be more closely approximated by taking into consideration the contribution made by each color to the luminance. Green, for example, may contribute approximately 60% to luminance, while red may contribute approximately 30%, and blue may contribute approximately 10%. Thus, increasing the green color component by a factor of “+1” (i.e., one color level), for example, will increase the luminance approximately 500% (i.e., six times) more than increasing the blue color component by the same “+1” factor.

In one example, if the source luminance 108 is relatively close in value to the hardware luminance 106, then only the blue color component may be chosen to be modified (as it has the smallest input on luminance). However, if the value of the source luminance 108 is further away from the value of the hardware luminance 106, then the red color component may be modified because the color red contributes a larger percentage to the overall luminance than the color blue. If the value of the source luminance 108 is even further away from the value of the hardware luminance 106, then the values of the red color component and the blue color component may both be raised (or lowered). If the value of the source luminance 108 is yet further away from the value of the hardware luminance 106, then the green color component may be modified because modification of the green component may account for a greater shift in the perceived luminance than modification of the red and blue color components. Likewise, if the value of the source luminance 108 is yet even further away from the value of the hardware luminance 106, then the values of the green color component and the blue color component may be both raised (or lowered). If the value of the source luminance 108 is still further away from the value of the hardware luminance 106, then the values of the green color component and the red color component may be both raised (or lowered). Accordingly, the luminance approximation may take into account the contribution of each individual color to the overall luminance when adding or subtracting color levels so as to more closely approximate the luminance of the source image 62.

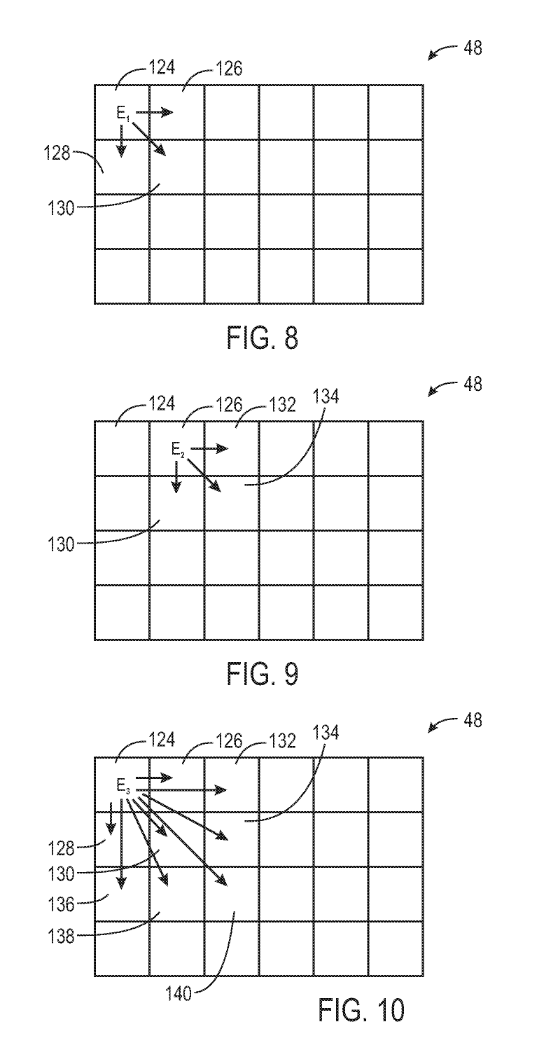

Returning again to FIG. 6, the application of the color quantization and luminance approximation may result in some deviations 116 (i.e., “errors”) between the luminance approximated image area 98 and the original image area 82. Such errors include the differences in color values between the RGB values of the original image and the RGB values of the luminance approximated image. In certain embodiments, such deviations 116 may be used to apply adjustments to nearby pixels in the image area 82 that have not yet been processed. Such a process may be termed “error diffusion” (block 118). In error diffusion, the color deviations that result from the quantization and luminance approximation may be propagated to neighboring pixels. For example, the error diffusion of block 118 may calculate a color error for each one of the RGB color components of a pixel. Such a color error may be computed by subtracting the color value of the luminance approximated pixel 98 from the color value of the original pixel of the image area 82. In one example, this color error may then be equally divided into two or more neighboring pixels. That is, some of the neighboring pixels may then be assigned an equal proportion of the color error and the assigned value may be used to increase (or decrease) the neighboring pixels' color values. In certain examples, the neighboring pixels may be assigned a proportion of the color error that may be different from the proportion of the color error assigned to other neighboring pixels, as described in more detail below with respect to FIGS. 8-10.

Once the error diffusion (block 118) is applied to the luminance approximated image area 98 using the deviations 116, then the logic 74 may determine at decision block 120 if all areas of the original source image 62 have been processed. If there are image areas still left unprocessed, then the logic 74 may iterate back to block 80 and continue with the image manipulation of the remaining image areas 82, as described above. Indeed, the logic 74 may iterate, for example, from left to right, then from top to bottom, selecting the next image area to manipulate until the entire source image 62 has been transformed from a high pixel depth image 62 to a low pixel depth image 70. The resulting low pixel depth image 70 is capable of being displayed in hardware having a lower pixel depth while presenting a visually pleasing image representative of the original original source image 62. Once the entirety of source image 62 gas been processed, the logic 74 may conclude (block 122).

Turning to FIG. 8, the figure illustrates an embodiment of error diffusion where a color error E₁ is diffused to neighboring pixels of the M×N matrix 48. In the illustrated embodiment, a pixel 124 may have undergone color quantization (block 84) and luminance approximation (block 96), and may thus contain a respective color error (i.e., deviation) for each of the RGB color components. For example, a color error E₁ for a red color channel may then be dispersed to the neighboring pixels 126, 128, and 130, as illustrated. In certain embodiments, E₁ is divided by the number of neighboring pixels 126, 128, and 130 and the result is proportionally distributed among the neighboring pixels. In the illustrated embodiment, each neighboring pixel 126, 128, and 130 would receive one third (i.e., E₁/3) of the error. Accordingly, E₁/3 of the red color channel would be added to each of the corresponding red color components of the pixels 126, 128, and 130.

In another embodiment, the error E₁ may be divided so that one or more neighboring pixels 126, 128, and 130 receive different proportions of the error. For example, half the error (i.e., E₁/2) may be added to the pixel 126, and one quarter of the error (i.e., E₁/4) may be added to the neighboring pixels 128 and 130. Assuming raster-order processing, such a disproportionate subdivision passes a larger proportion of the error to the neighboring pixel subsequent in line for undergoing luminance approximation (block 96). The luminance approximation 96 may thus process the larger error and may result in a more visually pleasing display image 70. Once the error E₁ is diffused, the next diffused, the next image area 82 (e.g., pixel) may be processed, as described in more detail with respect to FIG. 9 below.

FIG. 9 illustrates the pixel 126 of the M×N matrix 48 undergoing error diffusion. The pixel 126 may have received a portion of the error resulting from the color quantization and luminance approximation of the neighboring pixel 124. Accordingly, the pixel 126 may then also undergo color quantization and luminance approximation, which may result in a color error E₂. The color error E₂ may then be dispersed to the neighboring pixels 130, 132, and 134, as illustrated. Indeed, the color error E₂ may be processed in the same manner as described above with respect to the color error E₁ of FIG. 8. The entire source image 62 may be similarly processed by, for example, iterating pixel-by-pixel from left to right and from top to bottom of the image.

Turning to FIG. 10, the figure illustrates another example of luminance-based processing and error diffusion where the neighboring pixels used to diffuse the error are increased in number from those shown in FIGS. 8 and 9. Indeed, the illustrated embodiment shows an error E₃ being diffused among eight neighboring pixels 126, 128, 130, 132, 134, 136, 138, and 140 of the M×N matrix 48. It is to be understood that in other embodiments, more or less of the adjacent neighboring pixels may be selected for error diffusion. In the depicted embodiment, the error diffusion may be proportional or disproportional. If disproportional, then any number of divisional proportions may be assigned to the neighboring pixels 126, 128, 130, 132, 134, 136, 138, and 140. In certain embodiments, the error E₃ may not all be diffused to neighboring pixels and the pixel that originated the error E₃ may keep a portion of the error.

The resulting error diffusion may thus allow for a wider spread of the error which may result in a display image 70 that is of superior visual reproduction even when using lower pixel depths. Indeed, the techniques disclosed herein, including luminance-based dithering and error diffusion, may allow for approximating any number of source images into a lower pixel depth image with improved visual quality.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A dithering method for processing a source image comprising:
determining a luminance of a first area of the source image;
determining a color of the first area of the source image;
approximating the color of the first area of the source image to a nearest hardware-supported color;
varying the hardware-supported color of the first area to approximate the luminance of the first area;
determining a color error introduced by approximating the luminance of the first area; and
diffusing the color error to a second area of the source image, wherein the second area of the source image is immediately adjacent to the first area.

2. The method of claim 1, wherein the first area of the source image comprises a single pixel.

3. The method of claim 1, wherein the first area of the source image comprises a plurality of pixels.

4. The method of claim 1, wherein approximating a color of the first area to a nearest hardware-supported color comprises using the most significant bits of the approximated color to derive the hardware-supported color.

5. The method of claim 1, wherein varying the hardware-supported color of the first area to approximate the luminance of the first area comprises utilizing a first luminance equation Y=0.30 R+0.60 G+0.10 B, a second luminance equation Y′=0.30 R′+0.60 G′+0.10 B′, or a combination thereof.

6. The method of claim 1, wherein the diffusing the color error to a second area of the source image comprises distributing the color error to one or more receiving pixels in the second area, wherein each of the receiving pixels receives an approximately equal proportion of the color error.

7. The method of claim 1, wherein the diffusing the color error to a second area of the source image comprises distributing the color error to one or more receiving pixels in the second area, wherein the receiving pixels receive unequal proportions of the color error.

8. A non-transitory computer-readable medium comprising code adapted to:
decompose a source image into a plurality of color channels;
apply a luminance analysis to the color channels;
apply a luminance-based dithering to a first area of the source image based on the luminance analysis; and
diffuse a color error resulting from the luminance-based dithering to a second area of the source image.

9. The non-transitory computer-readable medium of claim 8, wherein the code adapted to decompose the source image into the plurality of color channels comprises code adapted to decompose the source image into at least red, green, and blue color channels.

10. The non-transitory computer-readable medium of claim 8, wherein the code adapted to apply a luminance analysis to the color channels comprises code adapted to approximate human perception of luminance.

11. The non-transitory computer-readable medium of claim 10, wherein the code adapted to approximate human perception of luminance comprises code adapted to utilize a first luminance equation Y=0.30 R+0.60 G+0.10 B, a second luminance equation Y′=0.30 R′+0.60 G′+0.10 B′, or a combination thereof.

12. The non-transitory computer-readable medium of claim 8, wherein the code adapted to apply the luminance-based dithering to the first area comprises code adapted to add or subtract a luminance approximation factor to the first area of the source image.

13. The non-transitory computer-readable medium of claim 8, wherein the code adapted to diffuse a color error resulting from the luminance-based dithering comprises code adapted to distribute a color error to two or more receiving pixels in a second area of the image, wherein the receiving pixels receive equal proportions of the color error, unequal proportions of the color error, or a combination thereof.

14. An electronic device comprising:
a display comprising a plurality of pixels; and
a processor configured to transmit signals representative of image data to the plurality of pixels of the display, wherein the processor is adapted to define a color matrix based on a first area of the source image, approximate the color matrix of the first area of the source image to a nearest hardware-supported color, and vary the color matrix of the first area to approximate the luminance of the first area by adding or subtracting a luminance approximation factor.

15. The electronic device of claim 14, wherein the luminance approximation factor comprises an increase of at least one color level, a decrease of at least one color level, or no change in the color level.

16. The electronic device of claim 14, wherein the color matrix comprise a red, green, or blue color matrix.

17. The electronic device of claim 14, wherein the defining the color matrix comprises eliminating least significant bits from a color value of the first area of the source image.

18. The electronic device of claim 17, wherein the first area of the source image comprises a pixel.

19. The electronic device of claim 14, wherein the processor configured to transmit signals representative of image data to the plurality of pixels of the display comprises a processor adapted to diffuse a color error to one or more receiving pixels in a second area, wherein the receiving pixels receive equal or unequal proportions of the color error.

20. A dithering method for processing a source image comprising:
color decomposing a source image;
selecting an area of the image to apply color quantization;
applying color quantization to the selected area to create a color quantized image area;
applying a luminance-based dithering (LBD) to the color quantized area to create an LBD image area and color deviations; and
error diffusing the color deviations to neighboring areas of the source image.

21. The method of claim 21, wherein the luminance-based dithering (LBD) comprises approximating the luminance level of the source image by adding to one or more color components of the color quantized image area if a luminance of the color quantized image area is smaller than the luminance level of the source image, or by subtracting from one or more color components of the color quantized image area if the luminance of the color quantized image area is greater than the luminance level of the source image.

22. The method of claim 21, wherein the error diffusing the color deviations to neighboring areas comprises distributing the color error to one or more receiving pixels in the neighboring areas, wherein each of the receiving pixels receives an approximately equal proportion of the color error.

23. The method of claim 21, wherein the error diffusing the color deviations to neighboring areas comprises distributing the color error to one or more receiving pixels in the neighboring areas, wherein the receiving pixels receive an unequal proportion of the color error.

24. An electronic device comprising:
a display comprising a plurality of pixels; and
a processor configured to transmit signals representative of image data to the plurality of pixels of the display, wherein the processor is adapted to select a first area of a color image; color decompose the first area into a plurality of color channels; create a plurality of color matrices, one for each of the color channels; apply a luminance analysis to the color matrices; apply a luminance-based dithering (LBD) to the first area to create an LBD image area and color deviations; and error diffuse the color deviations to neighboring areas of the source image.

25. The electronic device of claim 24, wherein the LBD comprises comparing a first luminance of the first image area to a second luminance of the color matrices, and adjusting the color matrices to more closely approximate the first luminance by adding or subtracting color levels from the color matrices.
